(19) United States
(12) Patent Application Publication
(10) Pub. No.: US 2022/0188502 A1
(43) Pub. Date: Jun. 16, 2022

(54) SYSTEMS AND METHODS FOR AUTOMATED VISUAL VALIDATION OF WEB ASSETS

(71) Applicant: DISCOVERY COMMUNICATIONS, LLC, Silver Spring, MD (US)

(72) Inventor: Brian SAYLOR, Silver Spring, MD (US)

(21) Appl. No.: 17/123,457

(22) Filed: Dec. 16, 2020

(51) Int. Cl. G06F 40/106; G06F 40/151; G06F 40/197; G06F 40/194

(52) U.S. Cl. CPC G06F 40/106; G06F 40/194; G06F 40/197; G06F 40/151

(57) ABSTRACT

The invention includes systems and methods to provide automated visual validation of web assets. The invention uses computer-controlled web browsers to view baseline and transformed versions of assets or web pages. The invention provides a side-by-side comparison of the baseline and transformed versions of the page and manages presentations to validators, in order to facilitate streamlined human validation of the transformed page. The invention provides a way for the results of validation to be tracked and reported to quickly and efficiently troubleshoot transformed page validations.

### TECHNICAL FIELD

This technology relates to methods and systems for automated visual validation of web assets. In particular, the technology provides improved systems and processes of performing quality assurance of transformed web pages, including structure and styling for large websites. The invention analyzes large volumes of web pages for visual aberrations to ensure that the transformed web pages meet quality standards and provides the desired visual result to end users. For example, the invention provides improved techniques to identify visual aberrations introduced in some (subsets of) transformed target pages.

### BACKGROUND

Internet content providers often run domains with large quantities of web assets (i.e., web pages). When those providers wish to perform non-deterministic updates to large amounts of the website content, additional validation and management is needed to determine whether such changes include problems.

In order to validate such changes, Internet content providers often rely upon computer automated validation. Although such validation is useful for deterministic changes, when changes are non-deterministic, computer automated validation breaks down. For example, computer automated validation may easily verify problems with reproduction of the web page itself, in many instances, the nature of the transformed web page precludes the use of computer automated validation alone. Instances, where computer automated validation does not identify all potential transformation problems may include, for example, data migration, large scale updating of a website, third party software upgrading/replacement, and/or artificial intelligence (AI) algorithm changes.

For example, a web provider with content related to cooking recipes (each recipe presented in a single web page) may transform each web page to a new web content management system. The transformed web page loses particular ingredients, places the recipe directions in the wrong order, loses entire sections of content (such as the title or chef's notes), or there are formatting problems with sections of content. Some of these problems may be identified by computer automated testing, however, non-deterministic or subject items such as formatting problems, directions in the wrong order, or with an ugly presentation may not be identified, since the content is still in the web page.

Transformations such as data migration may include re-ingesting large amounts of data for a website. For example, re-ingesting can include pulling parts of the data from a new or different source such that pages would render differently afterwards. Large visual changes such as transplantation of various sections of content in a webpage, that affect the presentation of vary large numbers of web pages, may result in rendering for each page that is unpredictable. Web content that may be changed may include title, section subject(s), reviews, descriptors, attribution information, web content management, summaries, media including image(s), audio, and/or video(s), notes, ads, etc. Third party software upgrades/replacements may include changes to Content Management System (CMS) software used by a website. The resulting changes may again result in rendering problems, which are unpredictable. Finally, AI algorithm changes may control how/what is displayed in one or more sections of a website, and thus any changes may result in rendering problems.

When performing transformations of content, structure, or styling for a large website, it may be desirable to perform qualitative checks to ensure that the end results achieve the desired results or that no visual aberrations are introduced in target pages. For example, in instances of stylistic changes rather than particular content changes.

It is difficult to manually view these changes without using more labor-intensive resources, such as having people click through web content from different web browsers to view the transformed page. Thus, in order to remedy these deficiencies, the automated visual validation system addresses these shortcomings.

A computer-implemented method for visual validation of a transformed web page across web browsing platforms by rendering an original web page of the transformed web page in a web browsing platform. The computer-implemented method also renders the transformed web page in the web browsing platform. The computer-implemented method stores a validation set including a screenshot of the rendered original web page and another screenshot of the rendered transformed web page of the web browsing platform. The computer-implemented method queues the validation set for presentation to a validator; presenting a visualization of the validation set to the validator. The computer-implemented method receives a validation from the validator including at least a pass or fail indication of the validation set.

In some embodiments, the computer-implemented method compares the validation to other validations of other validation sets to determine a pattern of issues among the validation and the other validation sets. In some embodiments of the computer-implemented method the comparison is presented in a report to a content provider of the original web page and transformed web page. In some embodiments of the computer-implemented method the validation includes a description of a problem with the transformed web page and information regarding the validation set. In some embodiments of the computer-implemented method the validation includes a location of the problem. In some embodiments of the computer-implemented method the visualization includes a navigation selector to another validation set. In some embodiments, the computer-implemented method the validation set includes a transformation identification, original web page address, transformed web page address, the screenshot, the another screenshot, and the web browsing platform. In some embodiments of the computer-implemented method the validation includes a remediation history. In some embodiments, the computer-implemented method selects the validator to visually validate the validation set based on the queue.

A computer system for visual validation of a plurality of transformed web page across web browsing platforms, the computer system including a processor configured to select one of a plurality of users to visually validate transformed web page, render an original web page in a web browsing platform, render the transformed web page of the web browsing platform, store a validation set including a screenshot of the rendered original web page and another screenshot of the rendered transformed web page of the web browsing platform, queue the validation set for presentation to a validator, present a visualization of the validation set to the validator; and receive a validation from the validator including at least a pass or fail indication of the validation set.

In some embodiments of the computer system, the processor compares the validation to other validations of other validation sets to determine a pattern of issues among the validation and the other validation sets. In some embodiments of the computer system the comparison is presented in a report to a content provider of the original web page and transformed web page. In some embodiments of the computer system the validation includes a description of a problem with the transformed web page and information regarding the validation set. In some embodiments of the computer system the validation includes a location of the problem. In some embodiments of the computer system the visualization includes a navigation selector to another validation set. In some embodiments of the computer system the validation set includes a transformation identification, original web page address, transformed web page address, the screenshot, the another screenshot, and the web browsing platform. In some embodiments of the computer system the validation includes a remediation history. In some embodiments of the computer system selects the validator to visually validate the validation set based on the queue.

### SUMMARY

The systems and methods of the claimed invention provide automated visual validation of transformed assets (e.g., web pages). The system uses computer-controlled web browsers to view and store baseline and transformed versions of assets or web pages. The invention provides scalability and easy accessibility for validators at any location and time. The invention provides a side-by-side comparison of the baseline and transformed versions of the web page and manages presentations to validators, in order to facilitate streamlined human validation of the transformed page. For example, the invention queues each baseline page as well as its transformation for validation by a plurality of users. The invention tracks valid and invalid transformations for reporting and for further remediation. The invention may also track the remediation history of each transformed page.

By presenting both the original and the transformed versions of the web page at the same time, the transformed page can be validated quickly by a validator. By providing an automated queuing of validation sets including the baseline content and transformed content, many validators can be utilized to validate a large amount of transformed content. By providing a queue, each validator may be selected based on requests for a next validation set. The system also provides a way for the validations to be tracked without accidental re-validation and for validators to quickly and efficiently troubleshoot transformed content validations by presenting continuously queued pages. The system provides approximately real-time updating of the transformed pages, and tracking and sorting of the validated images of the transformed content.

The systems and methods of the invention visually render the transformations of the web page in target web browsers (e.g., Chrome™, Firefox™, Safari™, Edge™, etc.), visually capturing each web page, using each of the target web browsers. The system scrolls the web page to force and trigger any lazy loaded images. Once the page or asset is fully loaded and rendered, the invention captures and stores the entire page display as an image. The invention may use the target web browsers in parallel to speed up the capture of these content presentations. The invention may also instruct the web browsers to suppress aspects of the pages to remove items unrelated to the transformations, as these items may be distracting to user validators in later steps of the process, thereby further speeding up the overall process. For example, ads banners in a web page may be suppressed to reduce unnecessary noise to the reviewer.

Once the system fully captures the transformed presentation for each targeted web browser, the system loads the captured baseline and transformed pages into a queue for validation. By providing validators access to the validation application at their leisure and in most any location with web browsing, the barriers to scalability and access or greatly reduced. When the user validators sign into the web interface, the system presents the validator with methods of navigation and validation through the queued web page, presenting the baseline and transformed versions side-by-side to allow the validator to concurrently scroll both versions. Using this side-by-side view, the validator can quickly scan and compare the versions for unintended effects or visual aberrations and then select a pass or fail element in the system which makes validation more efficient. For transformed pages that fail, the system provides the opportunity for the validator to describe and enter an additional description of the failure. Once the validator enters a validation designation (e.g., pass, fail, or issue), the interface may load the next set of baseline and transformed renderings for review, and the validated set may be removed from the queue. Many validators can use the validation interface of the invention simultaneously without having to coordinate among themselves, and the system presents each validator different validation sets to review.

### BRIEF DESCRIPTION OF THE DRAWINGS

FIG. 1 illustrates a system for visual validation of transformed web assets in accordance with the invention.

FIG. 2 shows a block diagram of components of a visual validation server in accordance with the invention.

FIG. 3 shows a diagram of a capture system using a visual validation server in accordance with the invention.

FIG. 4 illustrates a presentation of a visual validation application by a visual validation system in accordance with the invention.

FIG. 5 shows a flow chart for a method of use of a system for visual validation of transformed web assets for capture of a validation set in accordance with the invention.

FIG. 6 shows a flow chart for a method of use of a system for visual validation of transformed web assets for validation of a validation set in accordance with the invention.

### DETAILED DESCRIPTION

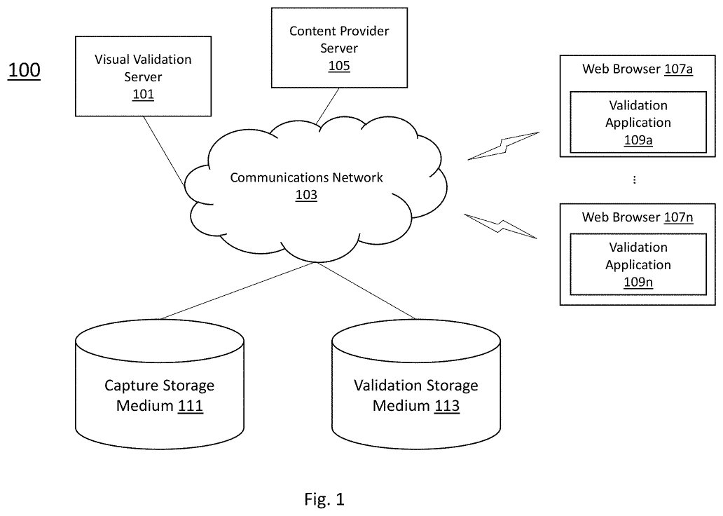

FIG. 1 illustrates an example system 100 for visual validation of transformed web assets, i.e., web pages, that includes a visual validation server 101, communications network 103, content provider server 105, web browsers 107a-107n, validation applications 109a-109n, capture storage medium 111, and validation storage medium 113, according to one example embodiment of the invention. System 100 may receive web pages and/or transformed web page. Visual validation server 101, which communicates with the content provider server 105 to collect and review historical web pages as well as transformed web pages either over a communication network, e.g., LAN, Cable, WLAN, or other wired or wireless network, or through a direct communication connection for storage in the capture storage medium 111. The server 101 may include a fully modular architecture that includes one or more distributed or centralized computing devices, e.g., servers, workstations, devices with processors and memory, etc. to enable a content provider to deploy the system 100. The server 101 functions include capture and validation of captured web pages. The architecture of the visual validation system 100 supports compact to large-scale deployment of the system 100 and ensures that storage and processing capabilities are robust and suitable for asset capture, processing, and storage operations. In other exemplary embodiments, the server 101 may be in direct communication with the capture storage medium 111 and validation storage medium 113 without communication through the content provider server 105. The web browsers 107a-107n access the visual validation application 109a-n via a cloud computing service, which includes a call to visual validation server 101.

An increasing need exists for providing better quality assurance of transformed web pages. The system 100 receives web pages as well as the transformed web pages (i.e., baseline and transformed versions) from the content provider server 105. The visual validation server 101 then captures the web pages and transformed web pages by fully loading and accessing the pages through web browsers. The loaded pages show what a user accessing the pages would view using a particular web browser. The system 100 then stores and queues the loaded pages as a validation set, commonly an image, for later access by a validator to scroll, view, and compare side-by-side. The system 100 does this for each baseline web page and each transformed version of the web page on each web browser.

Next, the visual validation server 101 provides a queued validation set and stores the validation results for each validation set. The queued validation sets are provided to validators which may navigate each set through calls to the visual validation server 101. The use of validation sets reduces wait time/cost for performing each validation. The queueing improves coordination of validation and provides flexibility to when/where a validation may occur. Further, the use of validation sets provides improved validations results since tracking/identification of results may be summarized and/or categorized into a report.

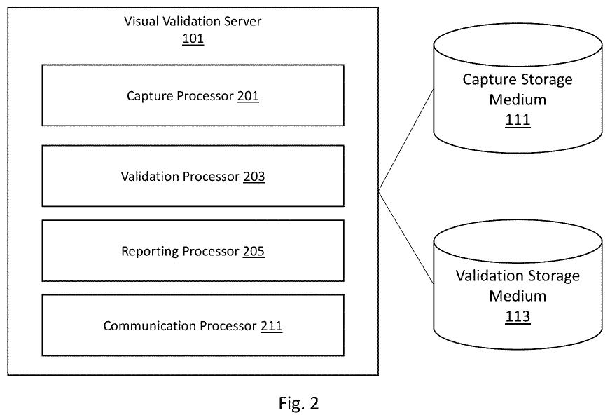

The FIGS. show an exemplary system of the invention for visual validation of provided web pages. For example, FIG. 1 shows a system 100 in accordance with the invention that receives baseline and transformed versions of web pages for capture and validation by validators. FIG. 2 provides a detailed breakdown of components included in the visual validation server 101.

The system 100 includes the visual validation server 101 that may be connected (wired or wirelessly) to a communications network 103. The communications network 103 may further be configured to communicate with content provider server 105, web browsers 107a-107n, and storage devices including at least capture storage medium 111, and validation storage medium 113. The communications network 103 may include any number of LAN, WLAN, Wi-Fi, cellular networks (e.g., 4G LTE and 5G networks), closed circuit networks, etc. In the exemplary embodiment of the invention shown in FIG. 1, the web browsers 107a-107n, as part of a validator device, i.e., any user device capable of running a web browser 107a-107n such as desktop, server, laptop, smart phone, etc., connect to the communications network 103 to access the validation application 109a-109n. The storage mediums 111 and 113 may include scalable storage mediums, databases, one or more server memory/storage, etc. as well as cloud storage devices from which the pages in the storage mediums 111 and 113 may be retrieved and/or stored. The web browsers 107a-107n may run validation applications 109a-109n accessing the visual validation server 101. The web browsers 107a-107n may be directed by the visual validation server 101 via the communications network 103 to present validation sets from the visual validation server 101, provide navigation through the queue of validation sets, and store results of validations for tracking and analysis.

The visual validation server 101 may capture pages, manage validations, and generate reports for validations. The visual validation server 101 captures a validation set including a baseline web pages as well as transformed web pages as presented in a target web browser and stores the validation sets in a capture storage medium 111. The visual validation server 101 may generate a queue of the validation sets stored in the capture storage medium 111. The visual validation server 101 may also manage navigation through validation sets. Further, the visual validation server 101 may also track and store validation results in the validation storage medium 113.

The content provider server 105 provides access to assets such as baseline web pages as well as transformations to the web pages to the visual validation server 101 for capture into validation sets. The content provider server 105 may request results of validations to be provided to it or a validator in order to determine solutions to transformation problems. The results provided identify at least each transformation problem, but also may identify subsets of baseline pages which have transformation problems. The content provider server 105 may also provide information suggesting problems have been resolved and/or should be re-validated to the visual validation server 101.

The web browsers 107a-107n may include any number of user devices which may run be used to browse the web pages. The web browsers 107 may run on devices include computing devices, such as laptops, desktops, personal communication devices such as cellular phones, etc. The web browsers 107, using the validation application 109, may request access to a validation queue from the visual validation server 101. The visual validation server 101 may then provide access to the validation application 109 via the web browsers 107 to the validating users.

As shown in further detail in server 101 of FIG. 2, the visual validation server 101 may include many component modules, processors, services, and applications to accomplish the visual validation of the transformed pages. Although FIG. 2 shows the server 101 as a single device, the server may include any number of processing devices that include various modules from server 101. Each module may include either a software or hardware solution, such as a computer processor, that meets the needs of the system 100. The server 101 may include a capture processor 201, validation processor 203, reporting processor 205, and communications processor 211. The server 101 may be configured to retrieve and store pages with the storage device mediums 111-113 including the capture storage medium 111 and validation storage medium 113.

The capture processor 201 is used with the communications processor 211 to receive baseline web pages and transformed web pages from the content provider server 105. The capture processor 201 uses one or more target web browsers (e.g., Chrome™, Firefox™, Safari™, Edge™, etc.) to open both the baseline web pages and the transformed web pages. The capture processor 201 navigates both versions (baseline and transformed) of the web page and scrolls the web pages to fully load/render the web pages along with any media, e.g., images, audio, and/or video, that is displayed in each target web browser. When fully loaded, the capture processor 201 captures an image of both fully loaded web presentations and stores them in the capture storage medium 111 for later validation. Further, the capture processor 201 may filter, as selected by content providers, particular portions of a web pages that do not need to be validated and/or would be distractions to validators, such as, advertisements, banners, unchanged modules (i.e., sub-sections of a web page) or web pages, sections still under development, movie clips, audio clips, pop-ups, other embedded objects, etc. The capture processor 201 may place the captured data in a queue for later validation by a plurality of validators. Although, in some examples, no order is established for the queue, in others, the queue may include ordering based on validation set groupings such as similar web pages or the same web page presented in different web browsers.

For example, a content provider wants to migrate large volumes of data in a website from one platform to another. In order to provide quality assurance for each page of web data, the capture processor 201 fully loads and captures each web page, as well as the transformed web page in a target web browser. In parallel, the capture processor 201 may also be loading and capturing each web page and transformed web page in one or more other target web browsers. The capture processor 201 may store each fully loaded web page as an image separately in the capture storage medium 111 with a database of baseline and associated transformed web pages, or simply store both images together as a validation set. The capture processor 201 may also filter portions of the web data which are deemed unchanged and/or distractions from the captured data. The stored validation set information may be placed in a database storing a queue for later validation tracking and navigation. The validation set may include at least both images, but also web page addresses for both the baseline and transformed web pages, and/or web browsing platform used in the capture of both images.

The validation processor 203 is used with the communications processor 213 to receive requests for access to the validation application 109, and then present the validation application to a validator. The validation processor 203 may access the capture storage medium 111 to access the validation sets based on the queue. The validation processor 203 may present each validation set in the validation application 109. A user validator may then scroll one or both images in the validation set to determine problems with the transformation. For example, the validator may flag the validation set as a “fail,” “issue,” or “pass.” If issues are found, the user validator may flag the validation set as “fail” or “issue” and describe the problems in a note. If the problem is, for example, formatting, or strangely worded titles or content, that is later editable, then the validator would flag the validation set as an “issue.” If the problem is something larger, that invalidates the transformation and may require an update of the transformation itself, such as stylistic, missing components, and formatting including using the wrong font; wrong color; missing information such as images, titles, decoration, or other content; elements in the wrong order; broken media, etc., then the validation set is flagged as “fail.” In other example embodiments, the validator may flag the validation set as “pass” or “fail.” The validation processor 203 may then store the validation result in the validation storage medium 113. For example, when a validator finds an aberration and flags the validation set. The validator may include information such as the location of the aberration and what the aberration is, e.g., content disfiguration, content not showing, etc. Once a validation is saved and/or if a validator does not want to act on a validation set, the validator may navigate to a previous or next validation set in the queue. Further, a validator's results may be tracked with the validation results in order to verify a validator is reviewing the validation sets appropriately.

The reporting processor 205 receives the validation results from the validation processor 203. The reporting processor 205 is used with the communication processor 211 to present validation results to the content provider. The reporting processor 205 may track and analyze the validation results for subsets of validation sets in the queue that include common problems. The subsets may include particular types of web content, transformation problems, and/or problems associated with particular web browsers. The validation results may include validation sets as a subset of the queue may indicate whether a particular transformation problem that can be solved by adjusting/changing the transformation itself, or if the subset is small enough that the problem may be resolved in one-off edits of the transformed web pages.

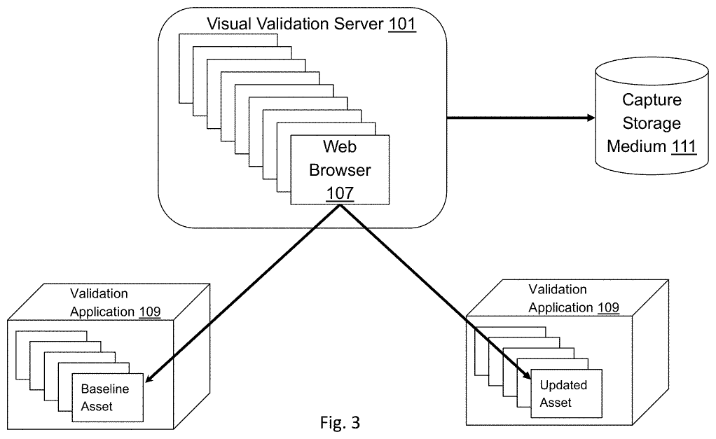

As shown in FIG. 3 shows a diagram of a capture system using a visual validation server 101 in accordance with the invention. The visual validation server 101 opens instances of each target web browser 107. The target web browsers 107 are instructed to fully load each baseline web page and transformed web page for capture and storage as a validation set in the capture storage medium 111. The web browsers 107 may be instructed to suppress or remove unrelated or distracting items in the loaded web page.

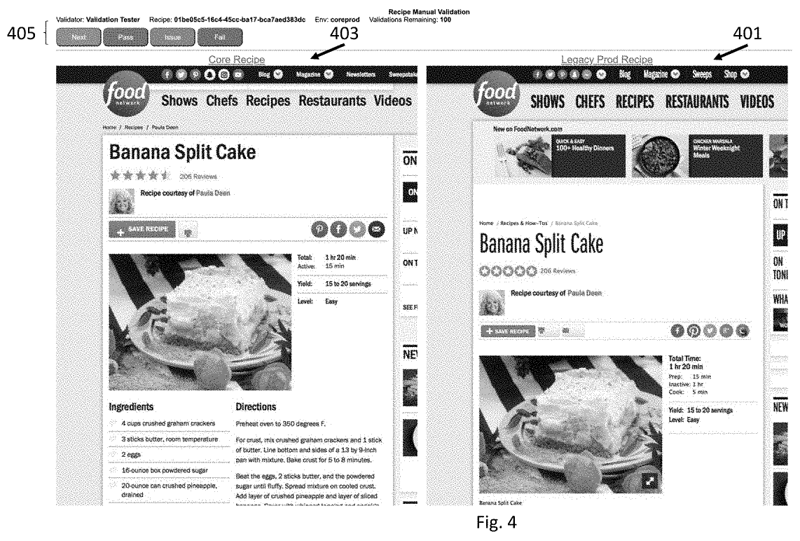

FIG. 4 illustrates a presentation of the visual validation application by the visual validation system. The visual validation application presents the baseline web page 401, transformed web page 403, and navigation and results buttons 405. The visual validation application may also present the number of validations remaining, the web page information, validator information, etc. to aid in validation tracking by the validators. The baseline web page 401 is presented on the left and the transformed web page 403 is displayed on the right. In other example embodiments, the baseline web page 401 and transformed web page 403 may be presented in other visually efficient manners, such as by opening two windows which may be configurable by the validator. The navigation and results buttons 405 may include selections to choose the “next” queued validation set without validation, and a selection of “pass,” “fail,” or “issue.” Selection of the “pass” button would increment to the next validation set in the queue without further action. Selection of the “fail” and “issue” buttons presents a note box or selector with selections of what problem(s) are seen and the location of those problems in the transformed web page 403.

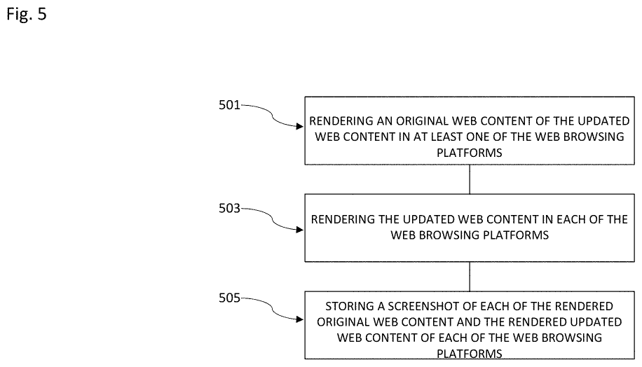

FIG. 5 shows a flow chart for a method of use of the visual validation of transformed web assets system for capture of a validation set in accordance with the invention. In step 501, the server 101 renders an original web page of the transformed web page in the web browsing platform. In step 503, the server 101 renders the transformed web page in the web browsing platform. In step 505, the server 101 stores a validation set including a screenshot of the rendered original web page and another screenshot of the rendered transformed web page of the web browsing platform. In step 507, the server 101 queues the validation set for presentation to a validator.

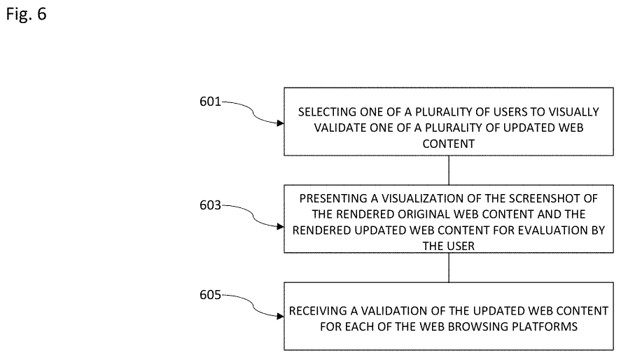

FIG. 6 shows a flow chart for a method of use of the visual validation of transformed web page assets system for validation of the validation set in accordance with the invention. In step 601, the server 101 presents a visualization of the validation set to the validator. In step 603, the server 101 receives a validation from the validator including at least a pass or fail indication of the validation set. For example, again in the example of the content provider providing cooking recipes, once the validator is available, they may access a queue of validation sets. The validator may review the validation set for problems such as changes in content, problems with formatting, etc. by providing the validator with a content checklist which may include whether the web page content matches in at least the title; times, yields, and levels; attribution; images/video/audio/media; nutrition; healthy/allergy/food restriction tags; ingredients; directions; etc.

The systems and methods of the invention provide visual validation. The invention processes a validation set of baseline and transformed web pages to be placed in a queue. The system presents the validation set for review by a validator. The system receives a validation result provided by the validator. The system reports validation results to a content provider.

1. A computer-implemented method for visual validation of a transformed web page across web browsing platforms comprising:
rendering an original web page in an original web browsing platform;
rendering the transformed web page in a transformed web browsing platform, wherein the transformed web page rendered in the transformed web browsing platform corresponds to the original web page rendered in the original web browsing platform;
storing a validation set in a database, the validation set including a screenshot of the rendered original web page and a screenshot of the rendered transformed web page;
queuing the validation set for presentation to a validator;
presenting a visualization of the validation set to the validator, wherein the presented validation set includes the screenshot of the rendered original web page and the screenshot of the rendered transformed web page; and
receiving a validation from the validator including at least a pass or fail indication of the validation set, wherein the pass or fail indication of the validation set includes an indication of unintended visual effects or aberrations.

2. A method of claim 1, further comprising:
comparing the validation received from the validator to other validations of other validation sets to determine a pattern of issues among the sets.

3. A method of claim 2, wherein the comparison is tracked and presented in a report to a content provider of the original web page and to a content provider of the transformed web page.

4. A method of claim 1, wherein the validation includes a description of a problem with the transformed web page, a location of the problem, and information regarding the validation set.

5. A method of claim 1 further comprising:
filtering the rendered web pages to remove a portion of the respective web pages from validation.

6. A method of claim 1, wherein the visualization includes a navigation selector to another validation set.

7. A method of claim 1, wherein the validation set includes a transformation identification, original web page address, transformed web page address, the screenshot of the rendered original web page, the screenshot of the rendered transformed web page, and the web browsing platform.

8. A method of claim 1, wherein the validation includes a remediation history.

9. A method of claim 1, further comprising:
selecting the validator to visually validate the validation set based on the queue.

10. A computer system for visual validation of a plurality of transformed web pages across web browsing platforms, the computer system comprising:
a processor configured to:
select one of a plurality of users to visually validate transformed web pages;
render an original web page in an original web browsing platform;
render the transformed web page in a transformed web browsing platform, wherein the transformed web page rendered in the transformed web browsing platform corresponds to the original web page rendered in the original web browsing platform;
store a validation set in a database, the validation set including a screenshot of the rendered original web page and a screenshot of the rendered transformed web page;
queue the validation set for presentation to a validator;
present a visualization of the validation set to the validator; and
receive a validation from the validator including at least a pass or fail indication of the validation set, wherein the pass or fail indication of the validation set includes an indication of unintended visual effects or aberrations.

11. A computer system of claim 10, wherein the processor is further configured to:
compare the validation received from the validator to other validations of other validation sets to determine a pattern of issues among the sets.

12. A method of claim 11, wherein the comparison is tracked and presented in a report to a content provider of the original web page and to a content provider of the transformed web page.

13. A computer system of claim 10, wherein the validation includes a description of a problem with the transformed web page and a location of the problem.

14. A computer system of claim 10, wherein the processor is further configured to:
filter the rendered web pages to remove a portion of the respective web pages from validation.

15. A computer system of claim 10, wherein the visualization includes a navigation selector to another validation set.

16. A computer system of claim 10, wherein the validation set includes a transformation identification, original web page address, transformed web page address, the screenshot of the rendered original web page, the screenshot of the rendered transformed web page, and the web browsing platform.

17. A computer system of claim 10, wherein the validation includes a remediation history.

18. A computer system of claim 10, wherein the processor is further configured to:
select the validator to visually validate the validation set based on the queue.

19. A method of claim 1 further comprising:
rendering the transformed web page in an additional transformed web browsing platform; and wherein
storing the validation set includes storing a screenshot of the transformed web page rendered in the additional web browsing platform.

20. A computer system of claim 10, wherein the processor is further configured to:
render the transformed web page in an additional transformed web browsing platform; and wherein
storing the validation set includes storing a screenshot of the transformed web page rendered in the additional web browsing platform.
